(19) United States
(12) Patent Application Publication
(10) Pub. No.: US 2010/0097299 A1
(43) Pub. Date: Apr. 22, 2010

(54) Plasma display device

(76) Inventor: Tae-Kyoung Kang, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 11/808,241

(22) Filed: Jun. 7, 2007

(30) Foreign Application Priority Data
Mar. 19, 2007 (KR) 10-2007-0026687

(51) Int. Cl. G09G 3/28

(52) U.S. Cl. 345/60

(57) ABSTRACT

A plasma display device. The plasma display is constructed with: a plasma display panel that displays visual images by using gas discharge; a chassis base that supports the plasma display panel; a driving board that applies a driving voltage to the plasma display panel; a connection wire connecting the driving board to an electrode included in the plasma display panel, and in which an electronic element is packaged; and a first member that adheres to the connection wire to absorb heat transmitted to the electronic element.

### CLAIM OF PRIORITY

This application makes reference to, incorporates the same herein, and claims all benefits accruing under 35 U.S.C. §119 from an application for PLASMA DISPLAY DEVICE earlier filed in the Korean Intellectual Property Office on 19 Mar. 2007 and there duly assigned Serial No. 10-2007-0026687.

### BACKGROUND OF THE INVENTION

1. Field of the Invention

The present invention relates to a plasma display device in which electronic elements are protected.

2. Description of the Related Art

A plasma display device displays visual images by using plasma generated through gas discharge.

The plasma display device is typically constructed with a plasma display panel (hereinafter referred to as a PDP), a chassis base for supporting the PDP, and a plurality of driving boards that are mounted on the surface of the chassis base opposite to the PDP and connected to display electrodes or address electrodes disposed in the PDP.

When electrodes such as address electrodes for selecting discharge cells are connected to the driving boards in order to select the discharge cells, the electrodes and the driving boards are connected by using a connection wire in which an integrated circuit element is packaged.

The connection wire in which the integrated circuit element is packaged may be directly connected to the driving board using an anisotropic conductive film or resin without using connectors.

The connection wire is connected to the driving board by heating the aforementioned anisotropic conductive film or resin. When the anisotropic conductive film or resin is heated, the heat generated in the anisotropic conductive film is conducted along the connection wire and reaches the integrated circuit, thereby undesirably damaging the integrated circuit element.

### SUMMARY OF THE INVENTION

It is therefore an object of the present invention to provide an improved plasma display device.

It is another object to provide a plasma display device that is capable of protecting an integrated circuit element against heat, even when a connection wire including the integrated circuit element is directly connected to a driving board.

According to an aspect of the present invention, there is provided a plasma display device constructed with: a plasma display panel that displays visual images by using gas discharge; a chassis base that supports the plasma display panel; a driving board that applies a driving voltage to the plasma display panel; a connection wire that connects the driving board to an electrode included in the plasma display panel, and in which an electronic element is packaged; and a first member that adheres to the connection wire to absorb heat transmitted to the electronic element.

In the above aspect of the present invention, the first member may be constructed with a recess for containing the electronic element, and a first thermally conductive member may be disposed between the electronic element and the recess on a wall of the recess that faces the electronic element to transmit the heat of the electronic element to the first member.

In addition, an adhesive agent may be disposed between the first member and the connection wire to allow the first member to adhere to the connection wire, and the adhesive agent may have a smaller surface area than that of the first member that faces the connection wire.

In addition, a heat dissipating plate may be formed extending in a longitudinal direction along an end portion of the chassis base and covering the first member. In this case, a second thermally conductive member may be disposed between the heat dissipating plate and the first member in order to transmit heat from the first member to the heat dissipating plate.

According to another aspect of the present invention, there is provided a plasma display panel constructed with: a plasma display panel that displays images by using gas discharge; a chassis base that supports the plasma display panel; a driving board that applies a driving voltage to the plasma display panel; a connection wire that connects the driving board to an electrode included in the plasma display panel, and in which an electronic element is packaged; and a second member that is disposed on a surface of the driving board, the surface being opposite to the surface of the driving board that contacts the connection wire. The second member may be positioned to correspond to the portion of the driving board that is connected the connection wire. Alternatively, the second member may be formed to cover the entire surface of the driving board, with the surface being opposite to the surface of the driving board that contacting connection wire.

According to another aspect of the present invention, there is provided a plasma display panel including: a plasma display panel that displays visual images by using gas discharge; a chassis base that supports the plasma display panel; a driving board that applies a driving voltage to the plasma display panel; a connection wire that connects the driving board to an electrode included in the plasma display panel, and in which an electronic element is packaged; a first member that adheres to the connection wire to absorb heat transmitted to the electronic element; and a second member that is disposed on a surface of the driving board, the surface being opposite to the surface of the driving board that contacts the connection wire.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view schematically illustrating a plasma display device constructed as a first embodiment according to the principles of the present invention;

FIG. 2 is a rear perspective view illustrating a first member that is installed in an electronic element;

FIG. 3 is a cross-sectional view taken along line III-III′ of FIG. 1; and

FIG. 4 is a cross-sectional view illustrating a plasma display device constructed as a second embodiment according to the principles of the present invention.

### DETAILED DESCRIPTION OF THE EMBODIMENTS

The present invention will be described more fully hereinafter with reference to the accompanying drawings, in which preferred embodiments of the invention are shown. As those skilled in the art would realize, the described embodiments may be modified in various different ways, all without departing from the spirit or scope of the present invention.

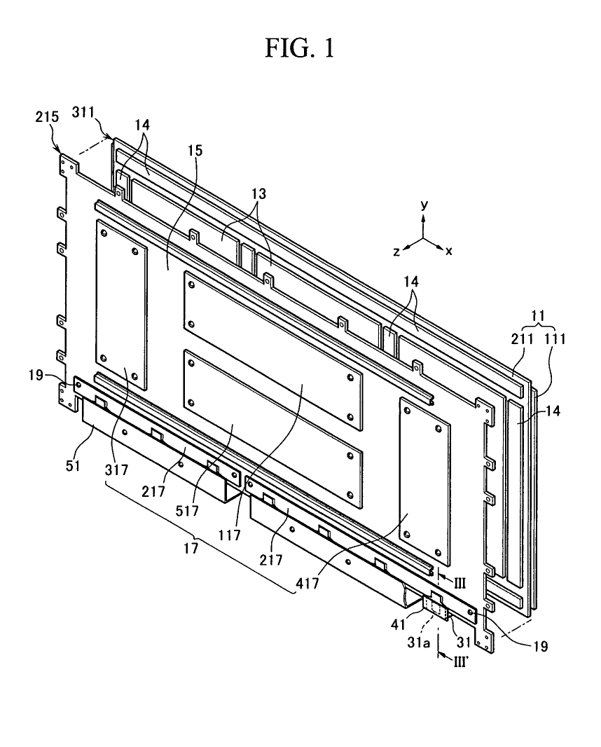

FIG. 1 is a perspective view schematically illustrating a plasma display device constructed as a first embodiment according to the principles of the present invention.

Referring to FIG. 1, the plasma display device is constructed with a plasma display panel (hereinafter simply referred to as a panel) 11 for displaying images using gas discharge, a chassis base 15 that adheres to rear surface 311 of panel 11, and driving boards 17 that are mounted on the rear side of chassis base 15 and electrically connected to panel 11 to apply a driving voltage.

Heat dissipating sheets 13 and double-sided tape 14 are inserted between rear surface 311 of panel 11 and front surface 215 of chassis base 15.

Heat dissipating sheets 13 are inserted between rear surface 311 of panel 11 and front surface 215 of chassis base 15 to diffuse and conduct heat in a planar direction. Heat dissipating sheets 13 may be made from an acrylic heat dissipating material, a graphite heat dissipating material, a metallic heat dissipating material, or a carbon nanotube heat dissipating material, which have good thermal conductivity.

Panel 11 adheres to chassis base 15 by using double-sided tape 14. Accordingly, heat dissipating sheets 13 closely adhere to rear surface 311 of panel 11 and front surface 215 of chassis base 15.

Panel 11 is constructed with front and rear substrates 111 and 211. Discharge cells (not shown) are formed by partitioning a space between front and rear substrates 111 and 211. The discharge cells include sub-pixels that are the smallest units. Address and display electrodes (for example, pairs of sustain and scan electrodes), which are not shown in FIG. 1, cross each other corresponding to the discharge cells. Images are displayed by gas discharge within the discharge cells.

On the other hand, the address and display electrodes are electrically connected to driving boards 17. Accordingly, the gas discharge of the discharge cells is controlled by driving boards 17.

Driving boards 17 apply the driving voltage through electrodes for inducing the gas discharge within each discharge cell. Driving boards 17 may be constructed with substrates and circuit elements (not shown) installed on the substrates, and may be fixed to bosses (not shown) of chassis base 15 by using screws 19. In FIG. 1, only the substrates of driving boards 17 are selectively illustrated as driving boards 17, as an example.

Driving boards 17 includes an image processing/control board 117, an address driving board 217, a scan driving board 317, a sustain driving board 417, and a power board 517 as function blocks.

Image processing/control board 117 receives image signals from outside of panel 11 and applies control signals for driving the address and display electrodes to address driving board 217 and either scan driving board 317 or sustain driving board 417. Address driving board 217 generates an address pulse and applies the address pulse to the address electrodes. Scan driving board 317 generates a scan pulse or a sustain pulse and applies the scan pulse or the sustain pulse to the scan electrodes. Sustain driving board 417 generates a sustain pulse and applies the sustain pulse to the sustain electrodes. Power board 517 supplies power needed for driving the plasma display device.

Here, a driving board such as address driving board 217, which selectively applies the driving voltage to the address electrodes, is connected to electrodes through a connection wire 31 in which an electronic element 31a is packaged. Electronic element 31a functions as a switch which selects a subset of address electrodes and applies the driving voltage supplied by address driving board 217 to the selected subset of address electrodes through connection wire 31. Electronic element 31a is packaged in connection wire 31 and protrudes beyond the surface of connection wire 31. In addition, connection wire 31 is directly connected to address driving board 217 through an anisotropic conductive film or resin (not shown in FIG. 1). Hereinafter, it is explained that address driving board 217 is connected to the address electrodes through connection wire 31 in which electronic element 31a is packaged, but the present invention is not limited to this case. In other words, connection wire 31 can be connected to any of driving boards 17.

Connection wire 31 in which electronic element 31a is packaged includes a first member 41 that protects electronic element 31a against heat or impact. First member 41 is disposed along connection wire 31.

First member 41 adheres to connection wire 31 to cover electronic element 31a, and first member 41 absorbs heat transmitted to electronic element 31a or dissipates heat generated by electronic element 31a while electronic element 31a operates. First member 41 is made from a material such as aluminum, iron, or copper, which has good thermal conductivity.

A heat dissipating plate 51 is formed in a longitudinal direction along chassis base 15 to cover first member 41. Heat dissipating plate 51 receives heat of electronic element 31a through first member 41 and dissipates the heat. Heat dissipating plate 51 is made from a material such as aluminum, iron, or copper, which has good thermal conductivity.

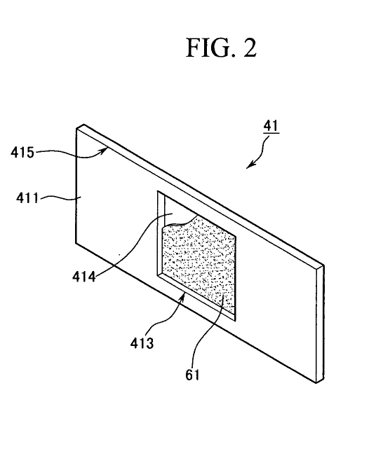

FIG. 2 is a perspective view illustrating a rear side of a first member 41 that is to be disposed on electronic element 31a, with rear surface 415 contacting connection wire 31 and electronic element 31a.

Referring to FIG. 2, first member 41 that is to be disposed on packaged electronic element 31a is constructed with a body 411 and a recess 413.

Body 411 has a rectangular shape with a specific volume to have a large contact area with connection wire 31. Body 411 receives heat transmitted from electronic element 31a and dissipates the heat from electronic element 31a.

Recess 413 is formed in body 411, oriented in a direction for receiving electronic element 31a. When first member 41 is disposed on connection wire 31, recess 413 receives electronic element 31a and prevents electronic element 31a from being mechanically broken.

A thermally conductive member 61 is further disposed on wall 414 of recess 413 that faces electronic element 31a. Body 411 contacts electronic element 31a through thermally conductive member 61. Accordingly, the heat generated from electronic element 31a is rapidly conducted to body 411 through thermally conductive member 61. In addition, electronic element 31a is protected against impact by first member 41.

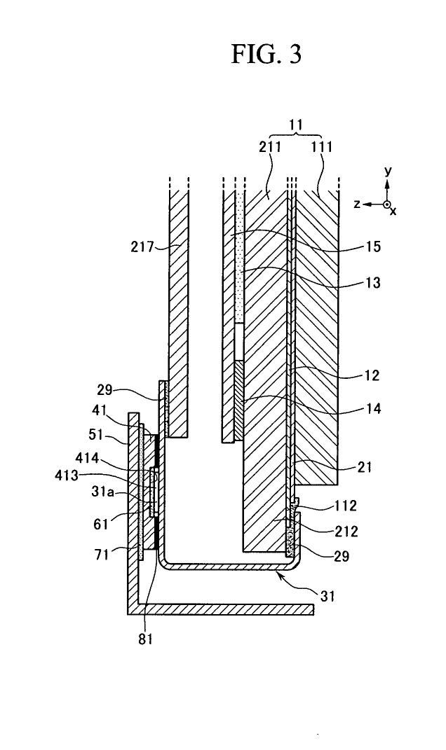

FIG. 3 is a cross sectional view taken along line III-III′ of FIG. 1.

Referring to FIG. 3, an address electrode 12 is constructed between front substrate 111 and read substrate 211 and extends to an end portion 212 of rear substrate 211, which does not overlap with front substrate 111. A dielectric layer 21 is formed to expose end portion 112 of address electrode 12.

Connection wire 31 is directly connected to address driving board 217 and address electrode 12 through an anisotropic conductive film 29. First member 41 adheres to connection wire 31 and contacts electronic element 31 through thermally conductive member 61 in order to protect electronic element 31a against heat by absorbing the heat transmitted to electronic element 31a when address driving board 217 is connected to address electrode 12 through connection wire 31.

On the other hand, first member 41 adheres to connection wire 31 to cover electronic element 31a. Recess 413 of first member 41 is oriented to receive electronic element 31a. Thermally conductive member 61 is disposed on wall 414 of recess 413, between electronic element 31a and first member 41.

First member 41 adheres to connection wire 31 through an adhesive agent 81. Adhesive agent 81 has a smaller surface area than that of first member 41, which faces connection wire 31. Adhesive agent 81 prevents impurities from adhering to electronic element 31a.

Heat dissipating plate 51 is formed to cover first member 41. A thermally conductive member 71 is formed between heat dissipating plate 51 and first member 41 to conduct the heat from first member 41 to heat dissipating plate 51.

When first member 41 is formed on connection wire 31, and when connection wire 31 is directly connected to address driving board 217 or address electrode 12 by heating anisotropic conductive film 29, first member 41 blocks the heat transmitted to electronic element 31a from connection wire 31 to protect electronic element 31a against the heat.

Further, first member 41 conducts heat, which is generated in electronic element 31a when panel 11 is driven, to heat dissipating plate 51 through first member 41 to protect electronic element 31a against the heat as well as mechanical impact.

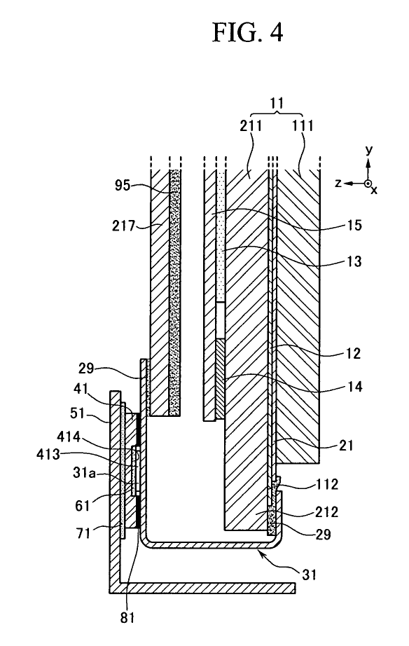

FIG. 4 illustrates a plasma display device constructed as a second embodiment according to the principles of the present invention. According to FIG. 4, address driving board 217 may selectively include a second member 95.

Second member 95 is formed on a surface of address driving board 217, the surface being opposite to the surface of address driving board 217 contacting connection wire 31. In other words, address driving board 217 is interposed between second member 95 and connection wire 31. Second member 95 may be positioned to correspond to a part of address driving board 217 that connects to connection wire 31. Alternatively, second member 95 may be formed on address driving board 217 to cover the entire address driving board 217, as illustrated in FIG. 4.

Since second member 95 faces the portion of driving board 217 connected to connection wire 31, when connection wire 31 is fixed to address driving board 217 by heating anisotropic conductive film 29, second member 95 can protect electronic element 31a against heat by receiving and diffusing the heat applied to connection wire 31.

In the above description, second member 95 is formed simultaneous with first member 41. Second members 95, however, may be formed independently of first member 41.

As described above, according to an embodiment of the present invention, since the first member is formed to cover the electronic element of the connection wire, the first member prevents heat, which is generated when the connection wire is directly connected to the driving board or the electrode by heating the anisotropic conductive film, from being transmitted to the electronic element in order to protect the electronic element against the heat.

In addition, the first member dissipates the heat generated when the electronic element is driven to prevent the electronic element from being damaged by heat.

Furthermore, since the first member includes a recess for receiving the electronic element, the first member can protect the electronic element against mechanical impact.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device, comprising:
a plasma display panel displaying visual images by using gas discharge;
a chassis base supporting the plasma display panel;
a driving board that applies a driving voltage to the plasma display panel;
a connection wire connecting driving board to an electrode included in the plasma display panel and in which an electronic element is packaged; and
a first member adhering to the connection wire to absorb heat transmitted to the electronic element.

2. The plasma display device of claim 1, with the first member comprising a recess for receiving the electronic element.

3. The plasma display device of claim 2, with a first thermally conductive member being disposed between the electronic element and the recess, on a wall of the recess that faces the electronic element in order to transmit the heat of the electronic element to the first member.

4. The plasma display device of claim 1, with an adhesive agent being disposed between the first member and the connection wire to allow the first member to adhere to the connection wire.

5. The plasma display device of claim 4, with the adhesive agent having a smaller surface area than that of the first member that faces the connection wire.

6. The plasma display device of claim 1, with a heat dissipating plate being formed to extend in a longitudinal direction along an end portion of the chassis base, covering the first member.

7. The plasma display device of claim 6, with a second thermally conductive member being disposed between the heat dissipating plate and the first member to transmit heat from the first member to the heat dissipating plate.

8. A plasma display device, comprising:
a plasma display panel displaying visual images by using gas discharge;
a chassis base supporting the plasma display panel;
a driving board that applies a driving voltage to the plasma display panel;
a connection wire connecting the driving board and an electrode included in the plasma display panel, and in which an electronic element is packaged; and
a second member that is disposed on a surface of the driving board, with the surface being opposite to the surface of the driving board that contacting connection wire.

9. The plasma display device of claim 8, with the second member being positioned to correspond to the portion of the driving board that is connected the connection wire.

10. The plasma display device of claim 8, with the second member being formed to cover the entire surface of the driving board, with the surface being opposite to the surface of the driving board that contacting connection wire.

11. A plasma display device, comprising:
a plasma display panel displaying visual images by using gas discharge;
a chassis base supporting the plasma display panel;
a driving board that applies a driving voltage to the plasma display panel;
a connection wire connecting the driving board and an electrode included in the plasma display panel, and in which an electronic element is packaged;
a first member adhering to the connection wire to absorb heat transmitted to the electronic element; and
a second member disposed on a surface of the driving board, the surface being opposite to the surface of the driving board that connects to the connection wire.

12. The plasma display device of claim 11, with the first member comprising a recess for receiving the electronic element.

13. The plasma display device of claim 12, with a first thermally conductive member being disposed between the electronic element and the recess, on a wall of the recess that faces the electronic element to transmit the heat of the electronic element to the first member.

14. The plasma display device of claim 11, with an adhesive agent being disposed between the first member and the connection wire to allow the first member to adhere to the connection wire.

15. The plasma display device of claim 14 with the adhesive agent having a smaller surface area than that of the first member that faces the connection wire.

16. The plasma display device of claim 11, with a heat dissipating plate being formed extending in a longitudinal direction along an end portion of the chassis base to cover the first member.

17. The plasma display device of claim 16, with a second thermally conductive member being disposed between the heat dissipating plate and the first member to transmit heat from the first member to the heat dissipating plate.

18. The plasma display device of claim 11, with the second member being positioned to correspond to the portion of the driving board that is connected the connection wire.

19. The plasma display device of claim 11, with the second member being formed to cover the entire surface of the driving board, with the surface being opposite to the surface of the driving board that contacting connection wire.
